(19) United States
(12) Patent Application Publication
(10) Pub. No.: US 2021/0203952 A1
(43) Pub. Date: Jul. 1, 2021

(54) ENCODER, ENCODING SYSTEM AND ENCODING METHOD

(71) Applicant: SZ DJI TECHNOLOGY CO., LTD., Shenzhen (CN)

(72) Inventors: Jianhua ZHANG, Shenzhen (CN); Bin HAN, Shenzhen (CN); Wenjun ZHAO, Shenzhen (CN)

(73) Assignee: SZ DJI TECHNOLOGY CO., LTD., Shenzhen (CN)

(21) Appl. No.: 17/198,105

(22) Filed: Mar. 10, 2021

Related U.S. Application Data
(63) Continuation of application No. PCT/CN2019/075746, filed on Feb. 21, 2019.

(51) Int. Cl. H04N 19/147; H04N 19/124; H04N 19/184

(52) U.S. Cl. CPC H04N 19/147; H04N 19/184; H04N 19/124

(57) ABSTRACT

An encoder, an encoding system and an encoding method are provided. The encoder includes: a first interface circuit to read pre-generated statistical information of a to-be-encoded image; a rate control circuit to determine a target bit rate of an image tile in the to-be-encoded image based on the statistical information of the to-be-encoded image; a first encoding circuit to perform tier-1 encoding on a code block of the image tile to obtain a bit stream of the image tile; and a second encoding circuit to perform tier-2 encoding on the bit stream of the image tile based on the target bit rate to truncate the bit stream of the image tile. The statistical information of the image tile in the to-be-encoded image is pre-calculated, and the bit stream of the image tile is truncated based on the statistical information, thereby reducing the system bandwidth required by the encoder.

### RELATED APPLICATIONS

This application is a continuation application of PCT application No. PCT/CN2019/075746, filed on Feb. 21, 2019, and the content of which is incorporated herein by reference in its entirety.

### COPYRIGHT NOTICE

A portion of the disclosure of this patent document contains material which is subject to copyright protection. The copyright owner has no objection to the facsimile reproduction by any one of the patent document or the patent disclosure, as it appears in the Patent and Trademark Office patent file or records, but otherwise reserves all copyrights whatsoever.

### TECHNICAL FIELD

This disclosure relates to the image decoding field, and more specifically, to an encoder, an encoding system and an encoding method.

### BACKGROUND

Joint Photographic Experts Group (JPEG) and JPEG 2000 are common image encoding standards.

JPEG 2000 employs wavelet transformation and performs entropy encoding based on embedded block coding with optimized truncation (EBCOT). JPEG 2000 has a higher compression rate than JPEG, and supports progressive downloading and displaying.

The rate control (i.e., bit rate control) algorithm of a conventional JPEG 2000 encoder performs global optimization for an entire image. Thus, a high system bandwidth is required.

### SUMMARY

This disclosure provides an encoder, an encoding system and an encoding method, which can reduce the system bandwidth requirements of a encoding process.

According to an aspect of the present disclosure, an encoder is provided, including: a first interface circuit, configured to read pre-generated statistical information of a to-be-encoded image from an external storage device; a rate control circuit, configured to determine a target rate of an image tile in the to-be-encoded image based on the statistical information of the to-be-encoded image; a first encoding circuit, configured to perform tier-1 encoding on at least one code block of the image tile to obtain a bit stream of the image tile; and a second encoding circuit, configured to perform tier-2 encoding on the bit stream of the image tile based on the target rate to truncate the bit stream of the image tile.

According to another aspect of the present disclosure, an encoding system is provided, including: a preprocessing circuit, configured to calculate statistical information of a to-be-encoded image; a storage device, configured to store the to-be-encoded image and the statistical information; and an encoder, configured to read the to-be-encoded image and the statistical information from the storage device, where the encoder includes: a first interface circuit, configured to read the statistical information of the to-be-encoded image from the storage device, a rate control circuit, configured to determine a target rate of an image tile in the to-be-encoded image based on the statistical information of the to-be-encoded image, a first encoding circuit, configured to perform tier-1 encoding on at least one code block of the image tile to obtain a bit stream of the image tile, and a second encoding circuit, configured to perform tier-2 encoding on the bit stream of the image tile based on the target rate to truncate the bit stream of the image tile.

According to yet another aspect of the present disclosure, an encoding method is provided, including: reading pre-generated statistical information of a to-be-encoded image from an external storage device; determining a target rate of an image tile in the to-be-encoded image based on the statistical information of the to-be-encoded image; performing tier-1 encoding on a code block of the image tile to obtain a bit stream of the image tile; and performing tier-2 encoding on the bit stream of the image tile based on the target bit rate to truncate the bit stream of the image tile.

Thus, the statistical information of the image tiles in the image to be encoded is calculated, and the bit stream of the image tile is truncated according to the statistical information, thereby performing relatively independent bit rate control on each image tile so as to reduce an encoder's requirement on the system bandwidth.

### BRIEF DESCRIPTION OF THE DRAWINGS

FIG. 1 is a diagram of an encoding architecture of JPEG 2000;

FIG. 2 is a schematic structural diagram of an encoding system according to some exemplary embodiments of this disclosure;

FIG. 3 is a schematic structural diagram of a preprocessing circuit according to some exemplary embodiments of this disclosure;

FIG. 4 is a schematic structural diagram of an encoder according to some exemplary embodiments of this disclosure;

FIG. 5 is a schematic diagram showing the principle of wavelet transformation on image tiles;

FIG. 6 is a schematic structural diagram of a decoder according to some exemplary embodiments of this disclosure; and

FIG. 7 is a schematic flowchart of an encoding method according to some exemplary embodiments of this disclosure.

### DETAILED DESCRIPTION

This disclosure may be applied to the image encoding/decoding field, the video encoding/decoding field, the hardware video encoding/decoding field, the dedicated circuit video encoding/decoding field, and the real-time video encoding/decoding field.

An encoder provided by this disclosure may be configured to perform lossy compression on an image, or may be configured to perform lossless compression on an image. The lossless compression may be visually lossless compression, or may be mathematically lossless compression.

For ease of understanding, an encoding architecture of JPEG 2000 is first briefly described.

As shown in FIG. 1, the encoding architecture of JPEG 2000 may include a preprocessing module 12 (the module is composed of one or more specific circuits), a transformation module 14 (the module is composed of one or more specific circuits), a quantization module 16 (the module is composed of one or more specific circuits), and an EBCOT module 18 (the module is composed of one or more specific circuits).

The preprocessing module 12 may include a component transformation module 122 (the module is composed of one or more specific circuits) and a direct current level shift (module 124 (the module is composed of one or more specific circuits).

The component transformation module 122 may perform a certain transformation on components of an image to reduce correlation between the components. For example, the component transformation module 122 may transform components of an image from a current color gamut to another color gamut.

The component transformation module 122 may support a plurality of color transformation modes. Therefore, the component transformation module 122 may be sometimes referred to as a multi-mode color transformation (MCT) module. For example, the component transformation module 122 may support irreversible color transformation (ICT) or reversible color transformation (RCT). It should be noted that the component transformation module 122 is optional. In an actual encoding process, alternatively, components of an image may not be transformed; instead, subsequent processing is directly performed.

The direct current level shift module 124 may be configured to perform a center shift on component values, so that the component values are symmetrically distributed about 0, to facilitate subsequent transformation operation.

The transformation module 14 may use wavelet transformation to transform image blocks (hereinafter “image tiles”) in an image to obtain a wavelet coefficient of a sub-band. In some exemplary embodiments of this disclosure, the size of an image tile is not specifically limited, for example, 512×512 (in the unit of pixel).

The quantization module 16 may be configured to quantize the wavelet coefficient of a sub-band to obtain a quantized wavelet coefficient of the sub-band.

The EBCOT module 18 is an entropy encoding module of JEPG 2000, and is a core module of JEPG 2000.

The EBCOT module 18 may include a tier-1 encoding module 182 (the module is composed of one or more specific circuits), a tier-2 encoding module 184 (the module is composed of one or more specific circuits), and a rate control module 186 (the module is composed of one or more specific circuits) (e.g., a module for bit rate control). The tier-1 encoding module 182 may be configured to perform tier-1 encoding on a code block (a sub-band may be further divided into a plurality of independent code blocks). The tier-1 encoding may include bit plane encoding and arithmetic encoding. The tier-2 encoding module 184 is mainly responsible for bit stream organization, for example, may perform processing such as truncation on a bit stream of a code block based on a target rate provided by the rate control module 186.

JPEG 2000 mainly uses a post-compression rate-distortion optimization (PCRD) algorithm for rate control. When rate control is performed with the conventional JPEG 2000 technology, an optimal truncation point set of bit streams of all code blocks in an image is calculated by traversal. In other words, rate control is performed on the entire image in the conventional JPEG 2000 technology. For a hardware encoder is expected to perform rate control on the entire image, massive intermediate data will be generated. In the case where the on-chip cache is limited, the encoder inevitably needs to perform massive data interactions with an external storage device (for example, a memory), and high system bandwidth is thus required.

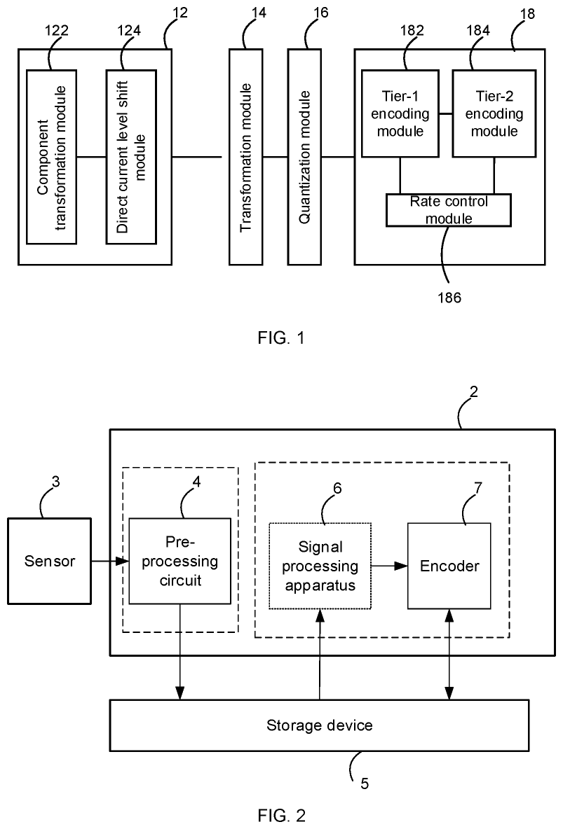

The following describes the technical solutions of this disclosure with reference to FIG. 2 to FIG. 6.

Some exemplary embodiments of this disclosure provide an encoding system. As shown in FIG. 2, the encoding system 2 includes a preprocessing circuit 4, a signal processing apparatus 6, and an encoder 7.

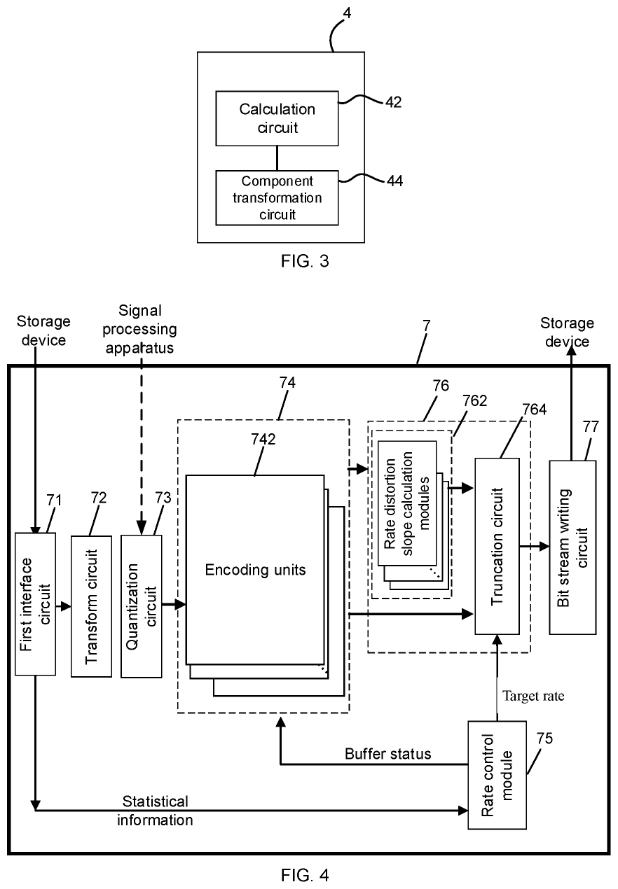

As shown in FIG. 3, the preprocessing circuit 4 may include a calculation circuit 42. The calculation circuit 42 may be configured to calculate statistical information of a to-be-encoded image. The to-be-encoded image may be an image captured by a sensor 3, or may be an image input by another device. The format of the to-be-encoded image may be RAW, or may be another format, for example, RGB. The function of the preprocessing circuit 4 may be performed by an image signal processing (ISP) subsystem (the ISP subsystem is represented by a dashed line box on the left in FIG. 2).

The statistical information of the to-be-encoded image may be information that can be used to perform rate control on an image tile in the to-be-encoded image. Therefore, in some exemplary embodiments, the statistical information of the to-be-encoded image may also be referred to as rate control information of a to-be-encoded image tile. The statistical information of the to-be-encoded image may include one or more types of the following information of the image tile in the to-be-encoded image: complexity, activity, and texture.

The statistical information of the to-be-encoded image may be calculated in different ways. In an example in which the statistical information of the to-be-encoded image is the complexity of the image tiles in the to-be-encoded image, the complexity of an image tile may be defined or calculated based on amplitudes of high-frequency components of pixels in the image tile. For example, the complexity of an image tile may be a cumulative sum of amplitudes of high-frequency components of pixels in an image tile region. When the texture of an image tile is complex, the corresponding cumulative sum of amplitudes of high-frequency components is also large, and it may be considered that the complexity of the image tile is high. Based on the image encoding theory, an encoded bit stream (or a quantity of bits consumed during encoding) corresponding to the image tile region with high complexity is also large. Specifically, the high-frequency components may be obtained by performing a filter operation based on pixel values of the pixels in the image tile region, and further, the complexity of the image tile is calculated.

In another example, the complexity of the image tile may be defined or calculated based on a mean square error (MSE) of the pixels in an image tile. If the MSE of the pixels in an t image tile is large, it may be considered that the complexity of the image tile is high.

Certainly, the complexity of an image tile may also be defined in another way, or in a combination of the foregoing ways. This is not limited in the embodiments of this disclosure.

In some exemplary embodiments, the preprocessing circuit 4 may further include a component transformation circuit 44. The component transformation circuit 44 may be configured to perform the aforementioned component transformation operation. Performing component transformation on the to-be-encoded image in the process of calculating the statistical information of the to-be-encoded image is equivalent to removing the operation originally to be performed by the encoder 7 from the encoder 7, and incorporating the operation into the preprocessing circuit 4 for implementation, so that the complexity of the encoder 7 can be reduced. Certainly, in other embodiments, alternatively, the component transformation operation may not be performed by the preprocessing circuit 4, but is still performed by the encoder 7.

Still referring to FIG. 2, a processing result (which may include the to-be-encoded image that is preprocessed and the statistical information of the to-be-encoded image) of the preprocessing circuit 4 may be stored in an external storage device 5. The storage device 5 may be a double data rate (double data rate, DDR) memory.

The encoder 7 may be a hardware encoder that supports the JPEG 2000 standard. As shown in FIG. 4, the encoder 7 may include a first interface circuit 71, a transformation circuit 72, a quantization circuit 73, a first encoding circuit 74, a rate control circuit 75 (e.g., a circuit to control bit rate), a second encoding circuit 76, and a bit stream writing circuit 77.

The first interface circuit 71 may be configured to read the pre-generated statistical information of an to-be-encoded image from the external storage device 5. The first interface circuit 71 may be further configured to read an image tile (this image tile may be any image tile in the to-be-encoded image) of the to-be-encoded image. The first interface circuit 71 may use a specific addressing mode to directly read the image tile of the to-be-encoded image stored from the storage device 5, without segmenting the to-be-encoded image. For example, to-be-encoded images may be sequentially stored in the storage device 5, and the first interface circuit 71 may calculate a storage location of each image tile based on a location of the to-be-encoded image in the storage device 5, and then read a corresponding image tile in an address jumping mode; or the to-be-encoded image may be stored in the storage device 5 as per image tiles, and the first interface circuit 71 may read the image tiles based on a storage sequence of the image tiles. The first interface circuit 71 may read the image tile from the storage device 5 in a direct memory access (DMA) mode.

The first interface circuit 71 may transmit the statistical information of the to-be-encoded image as rate control information to the rate control circuit 75, so that the rate control circuit 75 performs rate control on the encoding process.

In some exemplary embodiments, the first interface circuit 71 may be further configured to perform a direct current level shift on the image tile, that is, implement the function of the direct current level shift module 124.

The transformation circuit 72 may be configured to perform the operation previously performed by the transformation module 14, that is, perform the wavelet transformation on the image tile. After the wavelet transformation is performed on the image tile, a plurality of sub-bands may be obtained. After the wavelet transformation, wavelet coefficients of the image tile may be obtained, and the wavelet coefficients may be wavelet coefficients of these sub-bands.

The quantization circuit 73 may be configured to quantize the wavelet coefficients to obtain quantized wavelet coefficients or wavelet coefficients of quantized sub-bands.

It should be noted that, to reduce the complexity of the encoder 7, some or all operations such as transformation and quantization may be performed by the signal processing apparatus 6 shown in FIG. 2 instead. A type of the signal processing apparatus 6 in some exemplary embodiments of this disclosure is not specifically limited, for example, it may be a digital signal processor (DSP) or may be a graphics processing unit (GPU). In an example, some operations in transform operations may be performed by the signal processing apparatus 6, and the quantization circuit 73 in the encoder 7 may receive a transformation coefficient (wavelet coefficient) output by the transformation circuit 72 or may receive a transformation coefficient (wavelet coefficient) output by the signal processing apparatus 6. This may not only simplify the structure of the encoder 7, but also increase a degree of parallelism of the encoding process. In another example, all transformation operations may be performed by the signal processing apparatus 6, and the encoder 7 may only perform the quantization operation. In still another example, alternatively, the signal processing apparatus 6 may be responsible for all transformation and quantization operations, and the encoder 7 may perform encoding by directly using a quantization result. In some exemplary embodiments in which the signal processing apparatus 6 participates in operations, the signal processing apparatus 6 may use a specific addressing mode to directly read an image tile of the to-be-encoded image stored in the storage device 5, without segmenting the to-be-encoded image. For example, to-be-encoded images may be sequentially stored in the storage device 5, and the signal processing apparatus 6 may calculate the storage location of each image tile based on the location of the to-be-encoded image in the storage device 5 and then read the corresponding image tile in the address jumping mode; or the to-be-encoded image may be stored in the storage device 5 as per image tiles, and the signal processing apparatus 6 may read the image tiles based on the storage sequence of the image tiles. The signal processing apparatus 6 may read the image tile from the storage device 5 in the DMA mode.

When the signal processing apparatus 6 participates in the encoding process of an image tile, the signal processing apparatus 6 and the encoder 7 may be considered as an encoding subsystem (the encoding subsystem is represented by a dashed line box on the right in FIG. 2) of an entire system-on-chip (SOC).

The first encoding circuit 74 may be configured to perform tier-1 encoding on a code block of the image tile to obtain a bit stream of the image tile. With reference to the above descriptions, it can be known that a wavelet coefficient of a sub-band may be obtained after the transformation and quantization. One sub-band may also be divided into one or more code blocks that may be independently encoded. Therefore, the code block of the image tile is a code block of a sub-band of the image tile.

The first encoding circuit 74 may be configured to perform the operation performed by the tier-1 encoding module 182 in FIG. 1, for example, perform bit plane encoding and arithmetic encoding on the code block. In some exemplary embodiments, prior to encoding code blocks, the first encoding circuit 74 may further perform preprocessing on the code blocks, for example, separate sign bits of wavelet coefficients from absolute values of the wavelet coefficients. In addition, in some exemplary embodiments, after encoding the code blocks into bit streams, the first encoding circuit 74 may further perform post-processing on the code blocks, for example, may splice the bit streams for use by the second encoding circuit 76.

The rate control circuit 75 may be configured to determine a target rate of the image tile in the to-be-encoded image based on the statistical information of the to-be-encoded image.

In an example in which the statistical information of the to-be-encoded image is the complexity of the image tile in the to-be-encoded image, the rate control circuit 75 may assign a weight to each image tile based on the complexity of each image tile. The higher of the complexity of an image tile, the larger a weight thereof. Based on the weight of each image tile and a current network condition (for example, network bandwidth), the rate control circuit 75 may calculate the target rate of the image tile, so that the larger the weight of the image tile, the higher the target rate. In some exemplary embodiments, the statistical information of the to-be-encoded image that is output by the preprocessing circuit 4 may include the weight of each image tile, and the rate control circuit 75 may calculate the target rate by directly using the weight of the image tile.

The second encoding circuit 76 may be configured to implement the function of the foregoing tier-2 encoding module 184. For example, the second encoding circuit 76 may be configured to perform tier-2 encoding on the bit stream of the image tile based on the target rate to truncate the bit stream of the image tile.

The second encoding circuit 76 may include a rate distortion calculation circuit 762 (or referred to as a slope maker) and a truncation circuit 764 (or referred to as a truncator).

The rate distortion calculation circuit 762 may be configured to calculate a rate distortion slope of the bit stream output by the first encoding circuit 74. For example, the rate distortion calculation circuit 762 may calculate the rate distortion slope based on the rate and distortion of each bit stream (that is, the bit stream of each code block) output by the first encoding circuit 74. The rate distortion slope may be used to evaluate a contribution of the bit stream of the current code block in the entire image tile. The rate distortion slope may be used for subsequent bit stream organization, such as bit stream layering and truncation.

The truncation circuit 764 may be configured to process the bit stream of the image tile based on the target rate and the rate distortion slope. For example, the truncation circuit 764 may be configured to truncate the bit stream of the image tile based on the target rate and the rate distortion slope. Further, the truncation circuit 764 may be further used for bit stream reorganization, bit stream layering, and the like. In addition, in some exemplary embodiments, the truncation circuit 764 may be further configured to generate header information of the bit stream, and transmit the header information and the bit stream together to the next-stage bit stream writing circuit 77.

The bit stream writing circuit 77 may be configured to receive the bit stream organized and output by the truncation circuit 764, and write the bit stream to an external storage device. For example, the bit stream may be written to the external storage device through a bus. The bus may be, for example, an advanced extensible interface (AXI) bus. The bit stream writing circuit 77 may further append information such as an image tile header to the bit stream.

In some exemplary embodiments, the rate control circuit 75 may be further configured to generate status information of a rate control buffer (or referred to as buffer size) based on statistical information of the image tile. The first encoding circuit 74 may be further configured to control the tier-1 encoding based on the status information of the rate control buffer. The status information of the buffer may be used by the first encoding circuit 74 to pre-truncate the bit stream. For example, based on the status information of the buffer, the first encoding circuit 74 may delete a bit stream whose size exceeds a predetermined size, or delete a bit stream that does not comply with a requirement. Therefore, the status information of the buffer may be sometimes referred to as pre-truncation information. Further, in some exemplary embodiments, the rate control circuit 75 may further receive feedback about a size of the bit stream actually encoded by the first encoding circuit 74, and update pre-truncation information of the image tile under each resolution.

In some exemplary embodiments, the encoder 7 may further include an interface circuit (not shown in the figure) for software configuration. This interface circuit may be used to configure or change information in a register of the encoder 7, so as to control the encoding mode of the encoder 7.

In some exemplary embodiments of this disclosure, the statistical information of the image tile in the to-be-encoded image is pre-calculated, and the bit stream of the image tile is truncated based on the statistical information. Therefore, rate control is performed on each image tile relatively independently, and there is no need to perform overall optimization on all code blocks in the to-be-encoded image, and massive intermediate data is not generated. Therefore, system bandwidth required by the encoder may be reduced in some exemplary embodiments of this disclosure. The entire encoding process of the to-be-encoded image may be even completely performed on the chip.

The conventional JPEG 2000 encoding system may be understood as an online encoding system. The online encoding system directly inputs a to-be-encoded image (for example, an image captured by the sensor 3 in FIG. 2) to the encoder, and after encoding is complete, the to-be-encoded image is stored in the storage device 5. Different from the conventional JPEG 2000 encoding system, the encoding system provided by some exemplary embodiments of this disclosure firstly preprocesses the to-be-encoded image to obtain the statistical information of the to-be-encoded image (which may be used for rate control), and stores the preprocessed to-be-encoded image in the storage device 5. Then the encoder 7 may read and relatively independently process image tiles in the to-be-encoded image in units of image tiles. Since the to-be-encoded image is stored in the storage device 5 before the to-be-encoded image is encoded, subsequent encoding operations of the encoder are not performed online in real time. Therefore, the encoding system provided by some exemplary embodiments of this disclosure may be referred to as an offline encoding system.

In some exemplary embodiments, a cache (on-chip cache) may be disposed in the transformation circuit 72 or at an output end of the transformation circuit 72, and configured to temporarily store an intermediate result output by the transformation circuit 72.

In some exemplary embodiments, a cache (on-chip cache) may be disposed in the truncation circuit 764 or at an output end of the truncation circuit 764, and configured to temporarily store an intermediate result output by the truncation circuit 764.

In some exemplary embodiments of this disclosure, since image tiles may be encoded relatively independently, massive intermediate data is not generated. The cache may be configured to temporarily store some intermediate results generated on the chip.

To improve encoding efficiency of the encoder 7, in some exemplary embodiments, two adjacent stage circuits in the encoder 7 may be rate-matched. For example, for two adjacent stage circuits, a circuit with a low processing speed may be set to a multi-path parallel structure; and then a mechanism may be used to control data transmission between the two stage circuits, so that the two stage circuits are fully streamlined.

In an example, the quantization circuit 73 and the first encoding circuit 74 may be rate-matched. Specifically, as shown in FIG. 4, the first encoding circuit 74 may include a plurality of encoding units 742. The plurality of encoding units 742 may be configured to perform tier-1 encoding in parallel on various code blocks output by the quantization circuit 73, that is, the first encoding circuit 74 may use a multi-path parallel structure to perform tier-1 encoding.

The mode of group arbitration or free arbitration may be used between the quantization circuit 73 and the plurality of encoding units 742 to determine an encoding unit 742 corresponding to an intermediate result output by the quantization circuit 73. Group arbitration means always assigning a code block of a frequency component output by the quantization circuit 73 to a fixed group of encoding units (each group of encoding units may include several encoding units), and free arbitration means that each code block output by the quantization circuit 73 may be received by one of a plurality of parallel encoding units. An advantage of the group arbitration mode lies in its simple circuit connection in hardware implementation, while the free arbitration mode can improve utilization efficiency of the encoding units in some cases.

In another example, the first encoding circuit 74 and the rate distortion slope calculation circuit 762 may be rate-matched. For example, the rate distortion calculation circuit 762 may include a plurality of rate distortion slope calculation modules. The plurality of rate distortion slope calculation modules may be configured to calculate in parallel rate distortion slopes of bit streams output by the first encoding circuit 74. The group arbitration or free arbitration mode may also be used between the first encoding circuit 74 and the rate distortion calculation circuit 762 to determine a rate distortion calculation module corresponding to an intermediate result output by the first encoding circuit 74. Using group arbitration as an example, one rate distortion calculation module may correspond to one group of encoding units in the first encoding circuit 74. As one rate distortion calculation module corresponds to one group of encoding units, an entire circuit design becomes simpler.

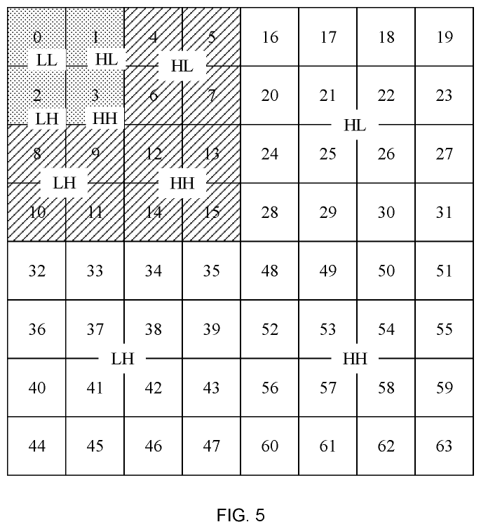

Using a 512×512 image tile shown in FIG. 5 as an example, the transformation circuit 72 generally divides the image tile into a plurality of 64×64 blocks to for transformation, and after each time of transformation, generates four 32×32 intermediate results, that is, four code blocks. In the last transformation, four code blocks are simultaneously output. In other cases, three code blocks (that is, code blocks corresponding to frequency components HL, LH, and HH) are output.

When three or four code blocks output by the transform circuit 72 are connected to the first encoding circuit 74 featuring multi-path parallelism via the quantization circuit 73, the group arbitration mode may be used to determine respective encoding units 742 corresponding to the code blocks.

It is assumed that the first encoding circuit 74 includes three groups of encoding units: a group 0, a group 1, and a group 2. The group 0 includes encoding units u0 to u3. The group 1 includes encoding units u4 to u7. The group 2 includes encoding units u8 to u11. Each image tile may include four 4 components (for example, R, Gr, Gb, and B). A mapping mode shown in the following table may be used to map code blocks of the components to the three groups of encoding units.

| | Time | Groups of encoding units | | | | | | | | | | | |
|---|---|---|---|---|---|---|---|---|---|---|---|---|---|
| | | Group 0 | | | | Group 1 | | | | Group 2 | | | |
| | | u0 | u1 | u2 | u3 | u4 | u5 | u6 | u7 | u8 | u9 | u10 | u11 |
| Com- | t0 | 16 | 17 | 18 | 19 | 32 | 33 | 34 | 35 | 48 | 49 | 50 | 51 |
| ponent | t1 | 20 | 21 | 22 | 23 | 36 | 37 | 38 | 39 | 52 | 53 | 54 | 55 |
| 0 | t2 | 24 | 25 | 26 | 27 | 40 | 41 | 42 | 43 | 56 | 57 | 58 | 59 |
| Com- | t3 | 28 | 29 | 30 | 31 | 44 | 45 | 46 | 47 | 60 | 61 | 62 | 63 |
| ponent | t4 | 4 | 5 | 6 | 7 | 8 | 9 | 10 | 11 | 12 | 13 | 14 | 15 |
| 2 | t5 | 0 | 1 | | | 2 | | | | 3 | | | |
| | | Group 0 | | | | Group 1 | | | | Group 2 | | | |
| | | u2 | u3 | u0 | u1 | u6 | u7 | u4 | u5 | u10 | u11 | u8 | u9 |
| Com- | t6 | 16 | 17 | 18 | 19 | 32 | 33 | 34 | 35 | 48 | 49 | 50 | 51 |
| ponent | t7 | 20 | 21 | 22 | 23 | 36 | 37 | 38 | 39 | 52 | 53 | 54 | 55 |
| 1 | t8 | 24 | 25 | 26 | 27 | 40 | 41 | 42 | 43 | 56 | 57 | 58 | 59 |
| Com- | t9 | 28 | 29 | 30 | 31 | 44 | 45 | 46 | 47 | 60 | 61 | 62 | 63 |
| ponent | t10 | 4 | 5 | 6 | 7 | 8 | 9 | 10 | 11 | 12 | 13 | 14 | 15 |
| 3 | t11 | 0 | 1 | | | 2 | | | | 3 | | | |

In the foregoing table, at a time point t5, encoding units u2 and u3 in the group 0 are in an idle state, and in this case, code blocks to be encoded at a time point t6 may be sent to the encoding units u2 and u3 in the group 0 in advance; at the time point t5, encoding units u5 to u7 in the group 1 are in the idle state, and in this case, code blocks to be encoded at the time point t6 may be sent to the encoding units u5 to u7 in the group 1 in advance; and at the time point t5, encoding units u9 to u11 in the group 2 are in the idle state, and in this case, code blocks to be encoded at the time point t6 may be sent to the encoding units u9 to u11 in the group 2 in advance. In this way, code blocks of components 0 and 2 and code blocks of components 1 and 3 are encoded with high efficiency in a ping-pong mode.

In addition, three rate distortion calculation modules may be disposed in the rate distortion slope calculation circuit 762, and a group arbitration mechanism may be used between the 12 encoding units and the three rate distortion calculation modules: u0 to u3 may be connected to the first rate distortion calculation module, u4 to u7 may be connected to the second rate distortion calculation module, and u8 to u11 may be connected to the third rate distortion calculation module.

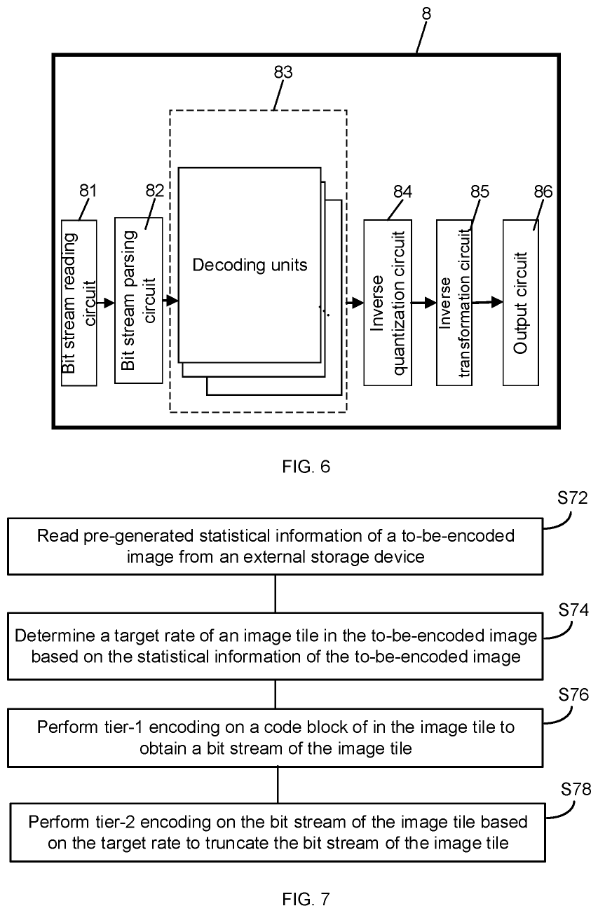

The structure of the encoder 7 provided by some exemplary embodiments of this disclosure is described above with reference to FIG. 4. The structure of a decoder 8 provided by some exemplary embodiments of this disclosure will be further described below with reference to FIG. 6.

As shown in FIG. 6, the decoder 8 may include one or more of the following circuits: a bit stream reading circuit 81, a bit stream parsing circuit 82, a decoding circuit 83, an inverse quantization circuit 84, an inverse transformation circuit 85, and an output circuit 86.

The bit stream reading circuit 81 may be configured to read a to-be-decoded bit stream. For example, the bit stream reading circuit 81 may read a to-be-decoded bit stream from an external storage device (for example, a memory) through an advanced extensible interface (AXI).

The bit stream parsing circuit 82 may also be referred to as a bit stream header parsing circuit (header parser). The bit stream parsing circuit 82 may parse various types of header information in the bit stream to extract parameters and bit stream data related to decoding to be used by the next-stage decoding circuit 83.

The decoding circuit 83 may include one decoding unit, or may include a plurality of parallel decoding units (a specific quantity may be configured based on an actual requirement; for example, eight parallel decoding units may be provided). Each decoding unit in the decoding circuit 83 may independently decode one code block.

In some exemplary embodiments, a preprocessing circuit may be further disposed before the decoding circuit 83. The preprocessing circuit may be configured to assign the decoding parameters, bit stream data, and the like output by the bit stream parsing circuit 82, to the plurality of parallel decoding units.

In some exemplary embodiments, a post-processing circuit may be further disposed after the decoding circuit 83. The post-processing circuit may be configured to reorganize decoded data output by the decoding circuit 83, and output organized data to a next-stage circuit.

The inverse quantization circuit 84 may be configured to perform inverse quantization on the data obtained through decoding by the decoding circuit 83.

The inverse transformation circuit 85 may be configured to perform inverse transformation on data output by the inverse quantization circuit 84. The inverse transformation may be discrete wavelet inverse transformation.

The output circuit 86 may be configured to write data output by the inverse transformation circuit 85 to an external storage device. For example, the data output by the inverse transformation circuit 85 may be written to an external storage device through AXI.

In some exemplary embodiments, the decoder 8 may further include a software configuration interface. The software configuration interface may be used to configure or change information in a register in the decoder 8, to control the decoding mode of the decoder 8.

The decoder 8 provided by some exemplary embodiments of this disclosure may perform decoding in units of image tiles. After the decoder 8 reads a bit stream from an external storage device, the entire decoding process may be performed on a chip (since decoding may be performed in units of image tiles in some exemplary embodiments of this disclosure, intermediate data is not massive and thus can be temporarily stored in an on-chip cache), without interaction with the external storage device, to save system bandwidth. In addition, all stage circuits in the decoder 8 may operate in a pipeline mode to improve decoding efficiency.

Some exemplary embodiments of this disclosure further provide an encoding method. The encoding method may be performed by the encoder 7 or encoding system mentioned previously. As shown in FIG. 7, the encoding method may include steps S72 to S78.

Step S72: Read pre-generated statistical information of a to-be-encoded image from an external storage device.

Step S74: Determine a target rate of an image tile in the to-be-encoded image based on the statistical information of the to-be-encoded image.

Step S76: Perform tier-1 encoding on a code block(s) in the image tile to obtain a bit stream of the image tile.

Step S78: Perform tier-2 encoding on the bit stream of the image tile based on the target rate to truncate the bit stream of the image tile.

In some exemplary embodiments, the method in FIG. 7 may further include: generating status information of a rate control buffer based on statistical information of the image tile; and controlling the tier-1 encoding based on the status information of the rate control buffer.

In some exemplary embodiments, the method in FIG. 7 may further include: reading the image tile from the storage device.

In some exemplary embodiments, the method in FIG. 7 may further include: performing a direct current level shift on the image tile.

In some exemplary embodiments, the method in FIG. 7 may further include: quantizing a wavelet coefficient of the image tile.

In some exemplary embodiments, step S76 may include: performing tier-1 encoding in parallel on code blocks of the image tile by using a plurality of encoding units.

In some exemplary embodiments, the plurality of encoding units include a plurality of groups of encoding units, and different groups of encoding units are configured to perform tier-1 encoding on code blocks of different frequency components of the image tile.

In some exemplary embodiments, the method in FIG. 7 may further include: performing wavelet transformation on the image tile.

In some exemplary embodiments, step S78 may include: calculating a rate distortion slope of the bit stream after the tier-1 encoding; and truncating the bit stream of the image tile based on the target bit rate and the rate distortion slope.

In some exemplary embodiments, the calculating a rate distortion slope of the bit stream after the tier-1 encoding may include: calculating in parallel rate distortion slopes of bit streams after tier-1 encoding by using a plurality of rate distortion slope calculation modules.

In some exemplary embodiments, at least a part of transformation coefficients or quantized coefficients of the to-be-encoded image are generated based on an external signal processing apparatus; and the method in FIG. 7 may further include: receiving the transformation coefficients or quantized coefficients generated by the signal processing apparatus.

In some exemplary embodiments, the statistical information of the to-be-encoded image includes complexity of the image tile in the to-be-encoded image.

In some exemplary embodiments, prior to reading pre-generated statistical information of a to-be-encoded image from an external memory, the method in FIG. 7 may further include: calculating the statistical information of the to-be-encoded image; and storing the statistical information of the to-be-encoded image in the storage device.

In some exemplary embodiments, prior to storing the statistical information of the to-be-encoded image in the memory, the method in FIG. 7 may further include: performing component transformation on the to-be-encoded image.

All or some of the foregoing exemplary embodiments may be implemented by software, hardware, firmware, or any combination thereof. When software is used to implement the exemplary embodiments, the exemplary embodiments may be implemented completely or partially in a form of a computer program product. The computer program product includes one or more computer instructions. When the computer instructions are loaded and executed on a computer, the procedure or functions according to some exemplary embodiments of the present disclosure are all or partially generated. The computer may be a general-purpose computer, a dedicated computer, a computer network, or other programmable apparatuses. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium may be any usable medium accessible by a computer, or may be a data storage device, such as a server or a data center, integrating one or more usable media. The usable medium may be a magnetic medium (for example, a floppy disk, a hard disk, or a magnetic tape), an optical medium (for example, a digital video disc (DVD)), a semiconductor medium (for example, a solid state disk (SSD)), or the like.

A person of ordinary skill in the art may appreciate that the units and algorithm steps in the examples described with reference to the exemplary embodiments disclosed in this specification can be implemented by electronic hardware or a combination of computer software and electronic hardware. Whether the functions are performed by hardware or software depends on particular applications and design constraints of the technical solutions. A person skilled in the art may use different methods to implement the described functions for each particular application, but it should not be considered that the implementation goes beyond the scope of this disclosure.

In some exemplary embodiments provided in this disclosure, it should be understood that the disclosed system, apparatus, and method may be implemented in other manners. For example, the described apparatus embodiments are merely exemplary. For example, the unit division is merely logical function division and may be other division in actual implementation. For example, a plurality of units or components may be combined or integrated into another system, or some features may be ignored or may not be performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network elements. Some or all of the units may be selected based on actual requirements to achieve the objects of the solutions of the embodiments.

In addition, functional units in the embodiments of this disclosure may be integrated into one processing unit, or each of the units may exist alone physically, or two or more units are integrated into one unit.

The foregoing descriptions are merely specific implementations of this disclosure, but are not intended to limit the scope of protection of this disclosure. Any variation or replacement readily conceived of by a person skilled in the art within the technical scope disclosed in this disclosure shall fall within the scope of protection of this disclosure. Therefore, the scope of protection of this disclosure shall be subject to the scope of protection defined in the claims.

What is claimed is:

1. An encoder, comprising:
a first interface circuit, configured to read pre-generated statistical information of a to-be-encoded image from an external storage device;
a rate control circuit, configured to determine a target rate of an image tile in the to-be-encoded image based on the statistical information of the to-be-encoded image;
a first encoding circuit, configured to perform tier-1 encoding on at least one code block of the image tile to obtain a bit stream of the image tile; and
a second encoding circuit, configured to perform tier-2 encoding on the bit stream of the image tile based on the target rate to truncate the bit stream of the image tile.

2. The encoder according to claim 1, wherein
the rate control circuit is further configured to generate status information of a rate control buffer based on statistical information of the image tile; and
the first encoding circuit is further configured to control the tier-1 encoding based on the status information of the rate control buffer.

3. The encoder according to claim 1, wherein the first interface circuit is further configured to read the image tile from the external storage device.

4. The encoder according to claim 1, wherein the first interface circuit is further configured to perform a direct current level shift on the image tile.

5. The encoder according to claim 1, further comprising:
a quantization circuit, configured to quantize a wavelet coefficient of the image tile.

6. The encoder according to claim 5, wherein
the first encoding circuit includes a plurality of encoding units configured to perform the tier-1 encoding in parallel on the at least one code block of the image tile.

7. The encoder according to claim 6, wherein
the plurality of encoding units includes a plurality of groups of encoding units; and
different groups of encoding units are configured to perform the tier-1 encoding on code blocks of different frequency components of the image tile.

8. The encoder according to claim 1, further comprising:
a transformation circuit, configured to perform wavelet transformation on the image tile.

9. The encoder according to claim 8, further comprising:
a first cache, configured to temporarily store an intermediate result output by the transformation circuit.

10. The encoder according to claim 7, wherein
the second encoding circuit includes:
a rate distortion calculation circuit, configured to calculate a rate distortion slope of the bit stream output by the first encoding circuit; and
a truncation circuit, configured to truncate the bit stream of the image tile based on the target rate and the rate distortion slope.

11. The encoder according to claim 10, wherein
the rate distortion calculation circuit includes:
a plurality of rate distortion slope calculation circuits, configured to calculate in parallel rate distortion slopes of bit streams output by the first encoding circuit.

12. The encoder according to claim 11, wherein
the plurality of rate distortion slope calculation circuits correspond to the plurality of groups of encoding units in the first encoding circuit on a one-to-one basis; and
each of the plurality of rate distortion slope calculation circuits is configured to calculate rate distortion slopes of bit streams output by a corresponding group of encoding units.

13. The encoder according to claim 10, further comprising:
a second cache, configured to temporarily store an intermediate result output by the truncation circuit.

14. The encoder according to claim 1, further comprising:
a second interface circuit, configured to receive transformation coefficients or quantization coefficients at least partially generated by an external signal processing apparatus.

15. The encoder according to claim 1, wherein the statistical information of the to-be-encoded image includes complexity of the image tile in the to-be-encoded image.

16. An encoding system, comprising:
a preprocessing circuit, configured to calculate statistical information of a to-be-encoded image;
a storage device, configured to store the to-be-encoded image and the statistical information; and
an encoder, configured to read the to-be-encoded image and the statistical information from the storage device, wherein
the encoder includes:
a first interface circuit, configured to read the statistical information of the to-be-encoded image from the storage device,
a rate control circuit, configured to determine a target rate of an image tile in the to-be-encoded image based on the statistical information of the to-be-encoded image,
a first encoding circuit, configured to perform tier-1 encoding on at least one code block of the image tile to obtain a bit stream of the image tile, and
a second encoding circuit, configured to perform tier-2 encoding on the bit stream of the image tile based on the target rate to truncate the bit stream of the image tile.

17. An encoding method, comprising:
reading pre-generated statistical information of a to-be-encoded image from an external storage device;
determining a target rate of an image tile in the to-be-encoded image based on the statistical information of the to-be-encoded image;
performing tier-1 encoding on a code block of the image tile to obtain a bit stream of the image tile; and
performing tier-2 encoding on the bit stream of the image tile based on the target bit rate to truncate the bit stream of the image tile.

18. The encoding method according to claim 17, further comprising:
generating status information of a rate control buffer based on statistical information of the image tile; and
controlling the tier-1 encoding based on the status information of the rate control buffer.

19. The encoding method according to claim 17, further comprising:
reading the image tile from the storage device.

20. The encoding method according to claim 17, further comprising:
performing a direct current level shift on the image tile.
